(19) United States
(12) Patent Application Publication
(10) Pub. No.: US 2026/0217966 A1
(43) Pub. Date: Jul. 30, 2026

(54) THERMOPLASTIC RESIN COMPOSITION AND USE THEREOF

(71) Applicant: KANEKA CORPORATION, Osaka-shi (JP)

(72) Inventors: Takenobu SUNAGAWA, Settsu-shi (JP); Arisa SONOYAMA, Settsu-shi (JP)

(73) Assignee: KANEKA CORPORATION, Osaka-shi (JP)

(21) Appl. No.: 19/629,134

(22) Filed: Mar. 26, 2026

Related U.S. Application Data
(63) Continuation of application No. PCT/JP2024/035545, filed on Oct. 4, 2024.

(30) Foreign Application Priority Data
Oct. 4, 2023 (JP) 2023-172664

(51) Int. Cl. C08L 67/04

(52) U.S. Cl. CPC C08L 67/04; C08L 2203/30; C08L 2205/025; C08L 2205/035; C08L 2312/00

(57) ABSTRACT

To provide a novel thermoplastic resin composition capable of providing a molded article excellent in impact resistance and moldability. Provided is a thermoplastic resin composition comprising: a poly(3-hydroxyalkanoate)-based copolymer (A); crosslinked resin particles (B); and a poly(3-hydroxybutyrate) homopolymer (C), wherein the crosslinked resin particles (B) comprise a polyhydroxyalkanoate-based resin and have a gel fraction of 50% or more, and a weight ratio [(C)/(A)] of the poly(3-hydroxybutyrate) homopolymer (C) to the poly(3-hydroxyalkanoate)-based copolymer (A) is 0.05 or more and 0.4 or less.

### TECHNICAL FIELD

The present invention relates to a thermoplastic resin composition and use thereof.

### BACKGROUND ART

Plastic waste has become a cause of imposing a burden on the global environment, such as impacts on ecosystems, generation of harmful gases during combustion, and global warming due to a large amount of combustion heat, and development of biodegradable plastics as materials capable of solving this problem has become active.

Patent Literature 1 describes a thermoplastic resin composition formed by blending 0.1 to 20 parts by weight of poly(3-hydroxyalkanoate) particles having an average particle diameter of 300 μm or less based on 100 parts by weight of poly(3-hydroxybutyrate-co-3-hydroxyhexanoate), and biodegradable and excellent in environmental compatibility.

### CITATION LIST

### Patent Literature

Patent Literature 1: Japanese Patent Application Publication, Tokukai, No. 2004-161802

### SUMMARY OF INVENTION

### Technical Problem

However, the conventional technology as described above was not sufficient in terms of the moldability of the thermoplastic resin composition and the impact resistance of the resulting molded article, and there remained room for further improvement.

One embodiment of the present invention has been made in view of the above situation, and an object thereof is to provide a novel thermoplastic resin composition capable of providing a molded article excellent in impact resistance and also excellent in moldability.

### Solution to Problem

The present inventors, as a result of diligent studies, have found that a thermoplastic resin composition containing a polyhydroxyalkanoate-based resin and containing crosslinked resin particles satisfying a specific gel fraction can provide a molded article excellent in impact resistance, and is also excellent in moldability, and thus have completed one embodiment of the present invention.

That is, one embodiment of the present invention includes the following configuration.

A thermoplastic resin composition comprising: a poly(3-hydroxyalkanoate)-based copolymer (A); crosslinked resin particles (B); and a poly(3-hydroxybutyrate) homopolymer (C), wherein the crosslinked resin particles (B) comprise a polyhydroxyalkanoate-based resin and have a gel fraction of 50% or more, and a weight ratio [(C)/(A)] of the poly(3-hydroxybutyrate) homopolymer (C) to the poly(3-hydroxyalkanoate)-based copolymer (A) is 0.05 or more and 0.4 or less.

### Advantageous Effect of Invention

According to one embodiment of the present invention, there can be provided a novel thermoplastic resin composition capable of providing a molded article excellent in impact resistance and also excellent in moldability.

### DESCRIPTION OF EMBODIMENTS

Although one embodiment of the present invention is described below, the present invention is not limited thereto. The present invention is not limited to the respective configurations described below, and various modifications can be made within the scope indicated in the claims. Embodiments or Examples obtained by combining the technical means respectively disclosed in different embodiments or Examples are also included within the technical scope of the present invention. Furthermore, new technical characteristics can be formed by combining the technical means respectively disclosed in the embodiments. It should be noted that all academic documents and patent documents described in the present specification are incorporated herein by reference. Also, unless otherwise specified in the present specification, “A to B” representing a numerical range is intended to mean “A or more (including A and more than A) and B or less (including B and less than B)”.

### [1. Thermoplastic Resin Composition]

A thermoplastic resin composition according to one embodiment of the present invention comprises: a poly(3-hydroxyalkanoate)-based copolymer (A); crosslinked resin particles (B); and a poly(3-hydroxybutyrate) homopolymer (C), wherein the crosslinked resin particles (B) comprise a polyhydroxyalkanoate-based resin and have a gel fraction of 50% or more, and a weight ratio [(C)/(A)] of the poly(3-hydroxybutyrate) homopolymer (C) to the poly(3-hydroxyalkanoate)-based copolymer (A) is 0.05 or more and 0.4 or less.

In the present specification, the “thermoplastic resin composition according to one embodiment of the present invention” may be referred to as “the present resin composition” in some cases. The crosslinked resin particles (B) contained in the present resin composition can also be referred to as crosslinked resin particles according to one embodiment of the present invention. In the present specification, the “crosslinked resin particles according to one embodiment of the present invention” may be referred to as “the present crosslinked resin particles” in some cases.

The present resin composition has an advantage that it can provide a molded article excellent in impact resistance. The present resin composition also has an advantage that it is excellent in moldability. In the present specification, the impact resistance of a molded article can be evaluated by the value of “50% fracture energy”. The method for measuring the 50% fracture energy (J) and the method for evaluating the moldability of the thermoplastic resin composition will be described in detail in Examples described below.

The polyhydroxyalkanoate-based resin contained in the present crosslinked resin particles (B) is a biodegradable resin. Therefore, the present crosslinked resin particles (B) can have biodegradability. Since the present resin composition comprises the crosslinked resin particles (B) that can have biodegradability, it is advantageous in terms of biodegradability.

First, the crosslinked resin particles (B) will be described.

### <Crosslinked Resin Particles (B)>

The crosslinked resin particles (B), that is, the present crosslinked resin particles (B), comprise a polyhydroxyalkanoate-based resin and have a gel fraction of 50% or more. In the present specification, the “polyhydroxyalkanoate-based resin” may be referred to as “PHA” in some cases. The present resin composition can provide a molded article excellent in impact resistance by comprising the present crosslinked resin particles (B). In other words, the present crosslinked resin particles (B) can be used as a modifier or an impact resistance improver for a thermoplastic resin.

“PHA” is a general term for polymers containing a hydroxyalkanoic acid as a monomer unit (monomer repeating unit) and generally has biodegradability. The PHA is aliphatic polyester and is preferably polyester that does not contain an aromatic ring. In the present specification, “PHA” refers to a polymer containing 50 mol % or more of a hydroxyalkanoic acid repeating unit out of the total monomer repeating units (100 mol %). It is preferable that the PHA contains 60 mol % or more of a hydroxyalkanoic acid repeating unit out of the total monomer repeating units (100 mol %), and it is more preferable that the PHA contains 70 mol % or more of a hydroxyalkanoic acid repeating unit.

The PHA is not particularly limited. Examples of the PHA include polyglycolic acid, poly(3-hydroxyalkanoate)-based resins (hereinafter referred to as “P3HA” in some cases), and poly(4-hydroxyalkanoate)-based resins. As the PHA, one type may be used alone, or two or more types may be used in combination. The PHA preferably comprises a poly(3-hydroxyalkanoate)-based resin, and is more preferably a poly(3-hydroxyalkanoate)-based resin (in other words, the PHA is constituted only by a poly(3-hydroxyalkanoate)-based resin).

In the present specification, “polyglycolic acid” refers to a resin containing 50 mol % or more of a repeating unit represented by [—CH₂—CO—O-] out of the total monomer repeating units (100 mol %). The polyglycolic acid may contain 60 mol % or more, 70 mol % or more, 80 mol % or more, or 90 mol % or more of a repeating unit represented by [—CH₂—CO—O-] out of the total monomer repeating units (100 mol %).

The polyglycolic acid may be a homopolymer of glycolic acid, or a copolymer of glycolic acid with a monomer other than glycolic acid (such as a copolymer of glycolic acid and lactic acid, or a copolymer of glycolic acid and caprolactone).

The polyglycolic acid can be obtained by a known method, such as condensation polymerization of glycolic acid and ring opening polymerization of glycolide.

The P3HA is polyhydroxyalkanoate containing a 3-hydroxyalkanoic acid repeating unit represented by the formula: [—CHR—CH₂—CO—O—], wherein R is an alkyl group represented by CₙH₂ₙ₊₁ and n is an integer of 1 or more and 15 or less, as an essential repeating unit. In the present specification, “P3HA” refers to a resin containing 50 mol % or more of the 3-hydroxyalkanoic acid repeating unit out of the total monomer repeating units (100 mol %). It is preferable that the P3HA contains 60 mol % or more of the 3-hydroxyalkanoic acid repeating unit out of the total monomer repeating units (100 mol %), and it is more preferable that the P3HA contains 70 mol % or more of the 3-hydroxyalkanoic acid repeating unit.

The P3HA is not particularly limited, and may be a homopolymer containing the aforementioned repeating unit, or a copolymer containing the aforementioned repeating unit. Examples of the copolymer may include a copolymer of 3-hydroxybutyric acid (hereinafter referred to as “3HB” in some cases) and one or more monomers selected from the group consisting of 3-hydroxypropionic acid, 3-hydroxypentanoic acid, 3-hydroxyhexanoic acid, 3-hydroxyheptanoic acid, 3-hydroxyoctanoic acid, 3-hydroxynonanoic acid, 3-hydroxydecanoic acid, 3-hydroxyundecanoic acid, 3-hydroxydodecanoic acid, 3-hydroxytridecanoic acid, 3-hydroxytetradecanoic acid, 3-hydroxyhexadecanoic acid, and 3-hydroxyoctadecanoic acid. Alternatively, other examples of the copolymer may include a copolymer of 3HB and one or more monomers selected from the group consisting of 4-hydroxybutyric acid, 4-hydroxypentanoic acid, 4-hydroxyhexanoic acid, 4-hydroxyheptanoic acid, 4-hydroxyoctanoic acid, 4-hydroxynonanoic acid, 4-hydroxydecanoic acid, 4-hydroxyundecanoic acid, 4-hydroxydodecanoic acid, 4-hydroxytridecanoic acid, 4-hydroxytetradecanoic acid, 4-hydroxyhexadecanoic acid, and 4-hydroxyoctadecanoic acid.

Examples of the P3HA include poly(3-hydroxybutyrate), which is a homopolymer of 3HB (hereinafter referred to as “P3HB” in some cases), poly(3-hydroxybutyrate-co-3-hydroxyhexanoate) (hereinafter referred to as “P3HB3HH” in some cases), and poly(3-hydroxybutyrate-co-4-hydroxybutyrate) (hereinafter referred to as “P3HB4HB” in some cases). As the P3HA, one type may be used alone, or two or more types may be used in combination. In the present specification, “poly(X-co-Y)” is a copolymer containing an X repeating unit and a Y repeating unit, and refers to a copolymer formed by copolymerizing a monomer serving as a source of the X repeating unit and a monomer serving as a source of the Y repeating unit. Furthermore, during microbial production of the P3HA, a minute amount (about 1 mol % or less) of a monomer may be copolymerized, but if the copolymerization of such a monomer does not significantly affect the physical properties of the resulting P3HA, that monomer is regarded as not copolymerized, and the P3HA is referred to by a name that does not include the monomer.

The P3HA can be produced by microorganisms. Such microbially produced P3HA is normally P3HA constituted only by a D-form (R-form) 3-hydroxyalkanoic acid repeating unit. Among microbially produced P3HA, P3HB, P3HB3HH, and P3HB4HB are preferable from the viewpoint of ease of industrial production, and P3HB3HH and P3HB4HB are more preferable.

It is also preferable that the P3HA contains a 3-hydroxybutyric acid (3HB) repeating unit. When the P3HA contains a 3HB repeating unit, from the viewpoint of the balance between flexibility and strength, the composition ratio of the 3HB repeating unit is preferably 60 mol % to 99 mol % in the total monomer repeating units (100 mol %), more preferably 61 mol % to 97 mol %, and still more preferably 62 mol % to 95 mol %. When the composition ratio of the 3HB repeating unit in the P3HA is 60 mol % or more, there is an advantage that the rigidity of the crosslinked resin particles can be further improved. On the other hand, when the composition ratio of the 3HB repeating unit in the P3HA is 99 mol % or less, there is an advantage that the flexibility of the crosslinked resin particles tends to be further improved. It should be noted that the monomer composition ratio of the P3HA can be measured by gas chromatography or the like (for example, see International Publication No. WO 2014/020838). As the P3HA, two or more types having different composition ratios of the 3HB repeating unit may be used in combination.

The microorganisms for producing the P3HA are not particularly limited, as long as they have the ability to produce the P3HA. For example, Bacillus megaterium, discovered in 1925, was the first known P3HB-producing bacterium, and other naturally occurring microorganisms such as Cupriavidus necator (formerly classified as Alcaligenes eutrophus or Ralstonia eutropha) and Alcaligenes latus are also known. In these microorganisms, the P3HB accumulates within the cells.

In addition, as bacteria for producing copolymers of 3HB and other hydroxyalkanoic acids, Aeromonas caviae, which is a P3HB3HH-producing bacterium, Alcaligenes eutrophus, which is a poly(3-hydroxybutyrate-co-4-hydroxybutyrate)-producing bacterium, and others are known. In particular, Alcaligenes eutrophus AC32 (FERM BP-6038), in which genes of the P3HA synthase group have been introduced to improve the productivity of P3HB3HH (T. Fukui, Y. Doi, J. Bacteriol., 179, p. 4821-4830 (1997)), is preferable. Microbial cells in which P3HA is accumulated by culturing such microorganisms under appropriate conditions are used. In addition to the above, recombinant microorganisms into which various P3HA synthesis-related genes have been introduced may be used depending on the P3HA to be produced, and optimization of the culture conditions, including the type of substrate, may be performed.

The weight average molecular weight of the PHA is not particularly limited. The weight average molecular weight of the PHA is preferably 50,000 to 3,000,000, more preferably 100,000 to 2,000,000, and still more preferably 150,000 to 1,500,000. When the weight average molecular weight of the PHA is 50,000 or more, there is an advantage that the tendency for the crosslinked resin particles to have lower strength can be reduced or avoided. In addition and/or alternatively, when the weight average molecular weight of the PHA is 50,000 or more, there is an advantage that the tendency for stickiness due to low molecular weight components can be reduced or avoided. On the other hand, PHA having a weight average molecular weight of 3,000,000 or less has the advantage that the PHA can be easily produced, and/or has the advantage that the PHA can be easily handled to achieve the object of one embodiment of the present invention. The numerical value of the weight average molecular weight of the PHA is a value obtained by measurement using the PHA before performing crosslinking treatment.

The measurement of the weight average molecular weight can be performed by using gel permeation chromatography (GPC) (“High Performance Liquid Chromatograph 20A System” manufactured by Shimadzu Corporation), using polystyrene gels (such as “K-G 4A” or “K-806M” manufactured by Showa Denko K.K.) as columns, and using chloroform as the mobile phase. The weight average molecular weight can be determined as a molecular weight in terms of polystyrene using a calibration curve obtained by measuring polystyrene of known molecular weights by the same measurement method. In this case, the calibration curve can be prepared using polystyrene with weight average molecular weights of 31,400, 197,000, 668,000, and 1,920,000. A column appropriate for measuring the molecular weight can be used as the column in the GPC.

### (Gel Fraction)

In the present specification, the “crosslinked resin particles” refer to resin particles having a crosslinked structure in which the molecular chains of the resin constituting the resin particles are bonded to each other, intramolecularly and/or intermolecularly. That is, the present crosslinked resin particles (B) may have a crosslinked structure in which the molecular chains of the PHA are bonded to each other. The amount of the crosslinked structure in the crosslinked resin particles affects the gel fraction of the crosslinked resin particles; specifically, the larger the amount of the crosslinked structure, the higher the gel fraction. Since the present crosslinked resin particles (B) have the crosslinked structure in a certain amount or more, they exhibit a high gel fraction, specifically a gel fraction of 50% or more. By the present crosslinked resin particles (B) having a gel fraction of 50% or more, the crosslinked resin particles have excellent hardness, heat resistance, and solvent resistance.

The value of the gel fraction is preferably 60% or more, more preferably 70% or more, still more preferably 75% or more, and particularly preferably 80% or more. Also, it may be 85% or more, or may be 90% or more. The upper limit of the gel fraction is not particularly limited, as long as it is 100% or less. From the viewpoint of production efficiency of the crosslinked resin particles, the upper limit of the gel fraction is preferably 99.5% or less, and more preferably 99% or less. Also, the upper limit of the gel fraction may be 98% or less, may be 97% or less, or may be 96% or less.

The gel fraction is a value measured as follows:
(1) A dried product of the crosslinked resin particles is added to chloroform so as to achieve a concentration of 0.7% by weight, and the resulting mixture is held at 60° C. for 30 minutes to obtain a chloroform solution;
(2) Thereafter, the chloroform solution is allowed to stand at room temperature for 3 hours, and the chloroform solution is then filtered through a membrane filter having a pore size of 0.45 μm; and
(3) The gel remaining on the filter is dried, the weight of the dried gel is measured together with the filter, and the gel fraction is calculated according to the following expression:

Gel fraction (%)={(Weight of the filter including the dried gel−Weight of the filter alone)/Weight of the dried product of the crosslinked resin particles used for the measurement}×100. Expression:

### (Volume Average Particle Diameter)

The volume average particle diameter of the present crosslinked resin particles is preferably 0.10 μm to 10.00 μm. According to this configuration, the crosslinked resin particles can be suitably used for various applications as will be described below. From the viewpoint of practical usability, the lower limit of the volume average particle diameter is more preferably 0.15 μm or more, and still more preferably 0.20 μm or more. Also, from the viewpoint of productivity (such as PHA production and/or crosslinking treatment), the upper limit of the volume average particle diameter is more preferably 8.00 μm or less, and still more preferably 5.00 μm or less.

In the present specification, the volume average particle diameter (MV) of the crosslinked resin particles is a value obtained by measurement using an aqueous dispersion in which the crosslinked resin particles are dispersed in an aqueous medium. More specifically, for a population of k crosslinked resin particles in total, the particle diameters of the individual crosslinked resin particles included in the population are denoted in ascending order as d1, d2, . . . , di, . . . , dk, and the volumes of these individual crosslinked resin particles are denoted as V1, V2, . . . , Vi, . . . , Vk (here, the volume of a crosslinked resin particle having a particle diameter of di is Vi). The volume average particle diameter (MV) of the crosslinked resin particles is a value calculated according to the following Expression (1), that is, Expression (2).

$$\begin{matrix}[ Expression 1 ] & \\ MV = \frac{V 1 \cdot d 1 + V 2 \cdot d 2 + … V i \cdot d i + … V k \cdot d k}{V 1 + V 2 + … V i + … V k} & ( 1 )\end{matrix}$$

$$MV = \frac{\sum ( V i \cdot d i )}{\sum ( V i )} \qquad ( 2 )$$

It should be noted that a general-purpose measurement apparatus can be used as a measurement apparatus for the volume average particle diameter of the crosslinked resin particles in the aqueous dispersion (in other words, for the particle diameter and volume of the crosslinked resin particles), and examples of such an apparatus include Microtrac MT3300EXII manufactured by Nikkiso Co., Ltd.

### (Peroxide)

The crosslinked structure in the present crosslinked resin particles (B) is not particularly limited, but it is preferable that the crosslinking is performed using a peroxide. That is, the present crosslinked resin particles (B) are preferably crosslinked using a peroxide. When a peroxide is used, radicals generated by the decomposition of the peroxide act on the molecules of the resin constituting the resin particles (for example, PHA). As a result, a crosslinked structure can be formed by direct bonding between the molecular chains of the resin constituting the resin particles.

When the crosslinked resin particles are those crosslinked using a peroxide, the aqueous dispersion containing the crosslinked resin particles may contain substances derived from the peroxide used for introducing the crosslinked structure (such as decomposition products of the peroxide and unreacted peroxide). Alternatively, when the crosslinked resin particles are those crosslinked using a peroxide, substances derived from the peroxide used for introducing the crosslinked structure (such as decomposition products of the peroxide and unreacted peroxide) may adhere to the surfaces or other parts of the obtained crosslinked resin particles. That is, when the present crosslinked resin particles (B) are those crosslinked using a peroxide, the present crosslinked resin particles (B) or the present resin composition may contain substances derived from the peroxide (such as decomposition products of the peroxide and unreacted peroxide). When the present crosslinked resin particles (B) or the present resin composition contains substances derived from a peroxide, by analyzing the crosslinked resin particles or the resin composition, it is found that the crosslinked resin particles were crosslinked using a peroxide.

The peroxide may be an organic peroxide, or may be an inorganic peroxide. Since the gel fraction can be increased more efficiently, the peroxide is preferably an organic peroxide.

As the organic peroxide, it is preferable to use at least one selected from the group consisting of diacyl peroxides, alkyl peroxy esters, dialkyl peroxides, hydroperoxides, peroxy ketals, peroxy carbonates, and peroxy dicarbonates, in consideration of factors such as the heating temperature and/or time during the crosslinking treatment.

Specific examples of such an organic peroxide include butyl peroxyneodecanoate, octanoyl peroxide, dilauroyl peroxide, succinic peroxide, a mixture of toluoyl peroxide and benzoyl peroxide, benzoyl peroxide, bis(butylperoxy)trimethylcyclohexane, butyl peroxylaurate, dimethyl di(benzoylperoxy)hexane, bis(butylperoxy)methylcyclohexane, bis(butylperoxy)cyclohexane, butyl peroxybenzoate, butyl bis(butylperoxy)valerate, dicumyl peroxide, di-t-hexyl peroxide, t-butyl peroxy-2-ethylhexanoate, t-butyl peroxyisobutyrate, t-butyl peroxypivalate, t-hexyl peroxypivalate, t-butyl peroxymethyl monocarbonate, t-pentyl peroxymethyl monocarbonate, t-hexyl peroxymethyl monocarbonate, t-heptyl peroxymethyl monocarbonate, t-octyl peroxymethyl monocarbonate, 1,1,3,3-tetramethylbutyl peroxymethyl monocarbonate, t-butyl peroxyethyl monocarbonate, t-pentyl peroxyethyl monocarbonate, t-hexyl peroxyethyl monocarbonate, t-heptyl peroxyethyl monocarbonate, t-octyl peroxyethyl monocarbonate, 1,1,3,3-tetramethylbutyl peroxyethyl monocarbonate, t-butyl peroxy-n-propyl monocarbonate, t-pentyl peroxy-n-propyl monocarbonate, t-hexyl peroxy-n-propyl monocarbonate, t-heptyl peroxy-n-propyl monocarbonate, t-octyl peroxy-n-propyl monocarbonate, 1,1,3,3-tetramethylbutyl peroxy-n-propyl monocarbonate, t-butyl peroxyisopropyl monocarbonate, t-pentyl peroxyisopropyl monocarbonate, t-hexyl peroxyisopropyl monocarbonate, t-heptyl peroxyisopropyl monocarbonate, t-octyl peroxyisopropyl monocarbonate, 1,1,3,3-tetramethylbutyl peroxyisopropyl monocarbonate, t-butyl peroxy-n-butyl monocarbonate, t-pentyl peroxy-n-butyl monocarbonate, t-hexyl peroxy-n-butyl monocarbonate, t-heptyl peroxy-n-butyl monocarbonate, t-octyl peroxy-n-butyl monocarbonate, 1,1,3,3-tetramethylbutyl peroxy-n-butyl monocarbonate, t-butyl peroxyisobutyl monocarbonate, t-pentyl peroxyisobutyl monocarbonate, t-hexyl peroxyisobutyl monocarbonate, t-heptyl peroxyisobutyl monocarbonate, t-octyl peroxyisobutyl monocarbonate, 1,1,3,3-tetramethylbutyl peroxyisobutyl monocarbonate, t-butyl peroxy-sec-butyl monocarbonate, t-pentyl peroxy-sec-butyl monocarbonate, t-hexyl peroxy-sec-butyl monocarbonate, t-heptyl peroxy-sec-butyl monocarbonate, t-octyl peroxy-sec-butyl monocarbonate, 1,1,3,3-tetramethylbutyl peroxy-sec-butyl monocarbonate, t-butyl peroxy-t-butyl monocarbonate, t-pentyl peroxy-t-butyl monocarbonate, t-hexyl peroxy-t-butyl monocarbonate, t-heptyl peroxy-t-butyl monocarbonate, t-octyl peroxy-t-butyl monocarbonate, 1,1,3,3-tetramethylbutyl peroxy-t-butyl monocarbonate, t-butyl peroxy-2-ethylhexyl monocarbonate, t-pentyl peroxy-2-ethylhexyl monocarbonate, t-hexyl peroxy-2-ethylhexyl monocarbonate, t-heptyl peroxy-2-ethylhexyl monocarbonate, t-octyl peroxy-2-ethylhexyl monocarbonate, 1,1,3,3-tetramethylbutyl peroxy-2-ethylhexyl monocarbonate, diisobutyl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-t-butylcyclohexyl) peroxydicarbonate, bis(2-ethylhexyl) peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-bis(2-ethylhexanoylperoxy)hexane, t-hexyl peroxy-2-ethyl hexanoate, di(4-methylbenzoyl) peroxide, dibenzoyl peroxide, t-butyl peroxy-2-ethylhexyl carbonate, t-butyl peroxyisopropyl carbonate, 1,6-bis(t-butylperoxycarbonyloxy)hexane, t-butyl peroxy-3,5,5-trimethylhexanoate, t-butyl peroxyacetate, t-butyl peroxybenzoate, t-amyl peroxy-3,5,5-trimethylhexanoate, 2,2-bis(4,4-di-t-butylperoxycyclohexyl)propane, and 2,2-di-t-butylperoxybutane. One of these organic peroxides may be used alone, or two or more thereof may be used in combination.

Among these, t-butyl peroxyisopropyl monocarbonate, t-pentyl peroxyisopropyl monocarbonate, t-hexyl peroxyisopropyl monocarbonate, t-butyl peroxy-2-ethylhexyl monocarbonate, t-pentyl peroxy-2-ethylhexyl monocarbonate, t-hexyl peroxy-2-ethylhexyl monocarbonate, t-amyl peroxyisopropyl monocarbonate, di-t-hexyl peroxide, t-butyl peroxy-2-ethylhexanoate, t-butyl peroxyisobutyrate, t-hexyl peroxy-2-ethylhexanoate, 1,1,3,3-tetramethylbutyl peroxy-2-ethylhexanoate, t-butyl peroxypivalate, t-hexyl peroxypivalate, t-butyl peroxyneodecanoate, t-hexyl peroxyneodecanoate, and 1,1,3,3-tetramethylbutyl peroxyneodecanoate are preferred organic peroxides because they can efficiently promote the crosslinking of the resin constituting the resin particles.

The peroxide is preferably a compound having a 1-hour half-life temperature of 200° C. or lower, more preferably a compound having a 1-hour half-life temperature of 170° C. or lower, and still more preferably a compound having a 1-hour half-life temperature of 140° C. or lower, since the heating temperature during the crosslinking treatment can be set low. The lower limit of the 1-hour half-life temperature of the peroxide may be 50° C. or higher, may be 60° C. or higher, or may be 70° C. or higher.

As the organic peroxide exhibiting such a 1-hour half-life temperature, t-butyl peroxyisopropyl monocarbonate, t-butyl peroxy-2-ethylhexyl monocarbonate, di-sec-butyl peroxydicarbonate, t-butyl peroxy-2-ethylhexanoate, t-butyl peroxyisobutyrate, t-hexyl peroxy-2-ethylhexanoate, 1,1,3,3-tetramethylbutyl peroxy-2-ethylhexanoate, t-butyl peroxypivalate, t-hexyl peroxypivalate, t-butyl peroxyneodecanoate, t-hexyl peroxyneodecanoate, and 1,1,3,3-tetramethylbutyl peroxyneodecanoate are particularly preferable.

A description will be given for the case where the peroxide is an inorganic peroxide. In consideration of the heating temperature and/or time during the crosslinking treatment, examples of the inorganic peroxide include hydrogen peroxide, potassium peroxide, calcium peroxide, sodium peroxide, magnesium peroxide, potassium persulfate, sodium persulfate, and ammonium persulfate. Among these, hydrogen peroxide, potassium persulfate, sodium persulfate, and ammonium persulfate are preferable in terms of ease of handling and having a decomposition temperature suited for the heating temperature during the crosslinking treatment. One of these inorganic peroxides may be used alone, or two or more thereof may be used in combination. Also, an organic peroxide and an inorganic peroxide may be used in combination.

### (Polyfunctional Compound)

The crosslinked structure in the present crosslinked resin particles (B) may be one introduced using only the peroxide, but may also be one introduced using both the peroxide and a polyfunctional compound. That is, the present crosslinked resin particles (B) may be crosslinked in the presence of the peroxide and the polyfunctional compound. When both the peroxide and the polyfunctional compound are used, it becomes possible to increase the gel fraction of the crosslinked resin particles with a smaller amount of peroxide, as compared with the case where only the peroxide is used.

The polyfunctional compound refers to a compound having, in one molecule, two or more functional groups (for example, radical reactive groups) capable of crosslinking the resin (for example, PHA) constituting the resin particles. The polyfunctional compound is not particularly limited, but a compound having reactivity with radicals generated from the peroxide is preferable, and a compound having, in one molecule, two or more radical reactive groups is particularly preferable. As the radical reactive group, at least one selected from the group consisting of a vinyl group, an allyl group, an acryloyl group, and a methacryloyl group is preferable.

Such a polyfunctional compound is not particularly limited, but examples thereof include allyl (meth)acrylate; allyl alkyl (meth)acrylates; allyloxyalkyl (meth)acrylates; polyfunctional (meth)acrylates having two or more (meth)acryl groups, such as ethylene glycol di(meth)acrylate, butanediol di(meth)acrylate, triethylene glycol di(meth)acrylate, tetraethylene glycol di(meth)acrylate, polyethylene glycol di(meth)acrylate, trimethylolpropane tri(meth)acrylate, and pentaerythritol (meth)acrylate; divinylbenzene, diallyl phthalate, triallyl cyanurate, triallyl isocyanurate, and divinylbenzene. The polyfunctional compound is preferably one or more selected from the group consisting of allyl methacrylate, triallyl isocyanurate, butanediol di(meth)acrylate, and divinylbenzene, and is particularly preferably one or more selected from the group consisting of allyl methacrylate and triallyl isocyanurate.

In the case where the crosslinked structure is formed in the presence of the polyfunctional compound, the obtained crosslinked resin particles can normally contain a structure derived from the polyfunctional compound. In this case, the molecular chains of the resin constituting the resin particles become bonded to each other via the structure derived from the polyfunctional compound.

### (Other Components)

The present crosslinked resin particles (B) are crosslinked resin particles containing PHA. Accordingly, the present crosslinked resin particles (B) may be crosslinked resin particles containing only PHA, or may be crosslinked resin particles containing other components in addition to PHA. Examples of the other components include a resin other than PHA, an antioxidant, a hydrolysis inhibitor, a blocking inhibitor, a nucleating agent, a lubricant, and an ultraviolet absorber.

The proportion of PHA in the present crosslinked resin particles (B) is not particularly limited. The amount of PHA in 100% by weight of the resin component of the present crosslinked resin particles (B) may be 50% by weight or more, is preferably 70% by weight or more, more preferably 80% by weight or more, even more preferably 90% by weight or more, particularly preferably 95% by weight or more, and may be 99% by weight or more. The upper limit of the amount of PHA in 100% by weight of the resin component of the present crosslinked resin particles (B) is not particularly limited, as long as it is 100% by weight or less. It should be noted that the “resin component of the crosslinked resin particles” refers to the resin that substantially constitutes the crosslinked resin particles, and does not include the component that crosslinks the molecular chains of the resin (for example, the structure derived from the polyfunctional compound) or residues of components used for crosslinking the molecular chains of the resin (for example, unreacted peroxide, decomposition products of the peroxide, unreacted polyfunctional compound, and the like).

Examples of the resin other than PHA include aliphatic polyester other than PHA and aliphatic-aromatic polyester. Examples of the aliphatic polyester other than PHA include (i) polycaprolactone (PCL), (ii) polylactic acid (PLA), and (iii) aliphatic polyester composed of a structure formed by polycondensation of an aliphatic diol and an aliphatic dicarboxylic acid. Specific examples of the aliphatic polyester having a structure formed by polycondensation of an aliphatic diol and an aliphatic dicarboxylic acid include polyethylene succinate, polybutylene succinate (hereinafter referred to as “PBS” in some cases), polyhexamethylene succinate, polyethylene adipate, polybutylene adipate, polyhexamethylene adipate, polybutylene succinate adipate (hereinafter referred to as “PBSA” in some cases), polyethylene sebacate, and polybutylene sebacate. Examples of the aliphatic-aromatic polyester include aliphatic-aromatic polyester obtained by using both an aliphatic compound and an aromatic compound as monomers and copolymerizing these monomers (using both an aliphatic compound and an aromatic compound as monomers). Examples of the aliphatic-aromatic polyester include polybutylene adipate terephthalate (hereinafter referred to as “PBAT” in some cases), polybutylene sebacate terephthalate (hereinafter referred to as “PBSeT” in some cases), polybutylene azelate terephthalate (hereinafter referred to as “PBAzT” in some cases), polybutylene succinate terephthalate (hereinafter referred to as “PBST” in some cases), and polybutylene succinate adipate terephthalate (hereinafter referred to as “PBSAT” in some cases). One of these resins other than PHA may be used alone, or two or more thereof may be used in combination. In the present crosslinked resin particles (B), the resin other than PHA may be either crosslinked or not crosslinked.

The present crosslinked resin particles (B) are different from foamed resin particles such as those disclosed in International Publication No. WO 2007/049694 and International Publication No. WO 2019/146555, and are preferably not foamed. In other words, it is preferable that the present crosslinked resin particles (B) are substantially free from bubbles inside the particles. The expression “substantially free from bubbles inside the particles” is intended to mean that, in 100% by volume of the crosslinked resin particles, the volume of bubbles (voids) is 10% or less.

When the present crosslinked resin particles (B) are not foamed, the apparent density of the crosslinked resin particles exhibits a relatively large value. The apparent density of the present crosslinked resin particles (B) is preferably more than 0.6 g/cm³, more preferably 0.7 g/cm³ or more, and still more preferably 0.9 g/cm³ or more. The apparent density of the present crosslinked resin particles (B) can be determined by the method described in JIS K0061 (Test methods for density and relative density of chemical products) or JIS Z8807 (Methods of measuring density and specific gravity of solid).

The average weight per particle of the present crosslinked resin particles (B) is not particularly limited. For example, when the volume average particle diameter of the present crosslinked resin particles (B) is 10.00 μm or less, the average weight per particle of the crosslinked resin particles can be a value far below 0.1 mg.

The present crosslinked resin particles (B) may be in a dried state. The shape after drying can have a shape such as a powder form, a pellet form, a crumb form, a film form, or a sheet form, depending on the drying method.

### (Method for Producing Crosslinked Resin Particles)

One example of a method for producing the present crosslinked resin particles (B) will be specifically described. The present crosslinked resin particles (B) can be produced by crosslinking the molecular chains of the resin in an aqueous dispersion containing resin particles before crosslinking treatment, in the presence of a peroxide. It should be noted that the term “resin particles” is intended to refer to particles constituted by the resin component that substantially constitutes the crosslinked resin particles. When the resin component is constituted only by PHA, the resin particles can also be referred to as PHA particles. To efficiently crosslink the molecular chains of the resin, it is preferable to heat the aqueous dispersion of the resin particles containing the peroxide to a temperature suited for decomposition of the peroxide.

More specifically, it is preferable that the method for producing the present crosslinked resin particles (B) includes: (1) a step of preparing an aqueous dispersion of resin particles in which resin particles before crosslinking treatment (for example, PHA particles) are dispersed in water; (2) a step of adding a peroxide to the aqueous dispersion of resin particles and impregnating the resin particles with the peroxide; and (3) a step of heating the aqueous dispersion of resin particles impregnated with the peroxide to a heating temperature to crosslink the molecular chains of the resin (for example, the molecular chains of PHA). It is more preferable that the method further includes (4) a step of maintaining the heating temperature after all of the peroxide has been added.

In step (1), for example, the aqueous dispersion of PHA particles may be an aqueous dispersion obtained by culturing PHA-producing microorganisms to accumulate PHA within the cells, then disrupting the cells in the culture solution, and separating and removing the cell components, or an aqueous dispersion obtained by concentrating or diluting the resulting aqueous dispersion. According to such methods, the processes from producing PHA particles by culturing the PHA-producing microorganisms to the crosslinking treatment can be carried out without separating the PHA particles from water.

Alternatively, the aqueous dispersion of resin particles (for example, PHA particles) can also be produced by dispersing dried resin particles (for example, PHA particles) in water.

The aqueous medium contained in the aqueous dispersion may be water alone, or may be a mixed solvent of water and an organic solvent miscible with water. In such a mixed solvent, the concentration of the organic solvent miscible with water is not particularly limited, as long as it does not exceed the solubility of the organic solvent used in water.

The organic solvent is not particularly limited, but examples thereof include alcohols such as methanol, ethanol, 1-propanol, 2-propanol, 1-butanol, 2-butanol, isobutanol, pentanol, hexanol, and heptanol; ketones such as acetone and methyl ethyl ketone; ethers such as tetrahydrofuran and dioxane; nitriles such as acetonitrile and propionitrile; amides such as dimethylformamide and acetamide; dimethyl sulfoxide; pyridine; and piperidine. Among these, methanol, ethanol, 1-propanol, 2-propanol, 1-butanol, 2-butanol, isobutanol, acetone, methyl ethyl ketone, tetrahydrofuran, dioxane, acetonitrile, propionitrile, and the like are preferable from the viewpoint of ease of removal. Also, methanol, ethanol, 1-propanol, 2-propanol, butanol, acetone, and the like are more preferable due to their ease of availability. Furthermore, methanol, ethanol, and acetone are particularly preferable.

The amount of water in the entire aqueous medium constituting the aqueous dispersion (100% by weight) is preferably 5% by weight to 100% by weight. The amount of water in 100% by weight of the aqueous medium is more preferably 10% by weight or more, more preferably 30% by weight or more, still more preferably 50% by weight or more, and particularly preferably 70% by weight or more. The amount of water in 100% by weight of the aqueous medium may also be 90% by weight or more, and may be 95% by weight or more.

It is preferable that, in the aqueous dispersion, the volume average particle diameter of the resin particles is within the same range as the volume average particle diameter of the above-described crosslinked resin particles. In the case of PHA particles produced by PHA-producing microorganisms, their volume average particle diameter may be normally within the above range, and therefore, an aqueous dispersion of PHA particles having a desirable volume average particle diameter can be obtained without carrying out any special step for adjusting the particle diameter.

The concentration of the resin particles in the aqueous dispersion is not particularly limited and may be set as appropriate, but for example, it may be about 1 to 70% by weight, and is preferably about 5 to 50% by weight.

The aqueous dispersion of resin particles preferably contains a dispersant in order to enhance the dispersibility of the resin particles and to allow the crosslinking reaction to proceed uniformly. Examples of the dispersant include anionic surfactants such as dioctyl sodium sulfosuccinate, sodium dodecyl sulfate, sodium lauryl sulfate, and sodium oleate; cationic surfactants such as lauryltrimethylammonium chloride; nonionic surfactants such as glycerin fatty acid esters, sorbitan fatty acid esters, sucrose fatty acid esters, polyoxyethylene alkyl ethers, polyoxyethylene alkylphenyl ethers, and polyoxyethylene-polyoxypropylene glycols; and water-soluble polymers such as polyvinyl alcohol, ethylene-modified polyvinyl alcohol, polyvinylpyrrolidone, methyl cellulose, ethyl cellulose, hydroxymethyl cellulose, hydroxyethyl cellulose, polyacrylic acid, sodium polyacrylate, potassium polyacrylate, polymethacrylic acid, and sodium polymethacrylate. One of these dispersants may be used alone, or two or more thereof may be used in combination.

When a dispersant is used, the amount (added amount) of the dispersant in the aqueous dispersion is not particularly limited. The amount of the dispersant in the aqueous dispersion is, for example, 0.1 parts by weight to 10 parts by weight, preferably 0.5 parts by weight to 5 parts by weight, and more preferably 0.5 parts by weight to 3 parts by weight, based on 100 parts by weight of the resin particles.

In step (2), a peroxide is added to the aqueous dispersion of resin particles obtained in step (1) to impregnate the resin particles with the peroxide. As the peroxide, those described above can be used. The peroxide can be added in various forms such as a solid form or a liquid form. Also, a liquid form diluted with a diluent or the like may be added. The peroxide may be added all at once, or may be added continuously or in divided portions.

When the peroxide and the polyfunctional compound described above are used in combination, it is preferable that the polyfunctional compound is also added to the aqueous dispersion of resin particles in step (2). As the polyfunctional compound, those described above can be used. The polyfunctional compound may be added in various forms such as a solid form or a liquid form. A liquid form diluted with a diluent or the like may also be added. The polyfunctional compound may be added all at once, or may be added continuously or in divided portions.

In step (2), as a method for impregnating the resin particles with the peroxide and the optional polyfunctional compound, there may be mentioned a method in which, after adding these compounds to the aqueous dispersion of resin particles, or while adding them, the temperature of the aqueous dispersion is set to, for example, 0° C. or higher and lower than a temperature suited for decomposition of the peroxide employed in the subsequent step (3), and while stirring the aqueous dispersion, the temperature is maintained for, for example, about 1 minute to 5 hours. Specifically, the temperature of the aqueous dispersion at the time of impregnation may be about 0° C. to 80° C., or about 10° C. to 60° C.

The amount of the peroxide used can be set as appropriate in consideration of the gel fraction of the crosslinked resin particles. The amount of the peroxide used is preferably 0.01 parts by weight to 10 parts by weight, more preferably 0.1 parts by weight to 8 parts by weight, still more preferably 0.3 parts by weight to 5 parts by weight, and particularly preferably 0.5 parts by weight to 3 parts by weight, based on 100 parts by weight of the resin particles.

According to the production method in which the resin particles are crosslinked in an aqueous dispersion by using a peroxide, it is easy to allow the crosslinking to proceed while maintaining the particle diameter (volume) before crosslinking, thereby obtaining the crosslinked resin particles. On the other hand, a method in which the resin is crosslinked by melt kneading in the presence of a peroxide may have difficulty in achieving this.

Also, according to the production method in which the resin particles are crosslinked in an aqueous dispersion by using a peroxide, it is easy to control the temperature increase caused by the heat generated during the crosslinking reaction, and there is an advantage that crosslinked resin particles having a safe and stable crosslinked structure (quality) can be efficiently obtained.

Also, the amount of the polyfunctional compound used may be set as appropriate in consideration of the gel fraction of the crosslinked resin particles. The amount of the polyfunctional compound used is preferably 0.01 parts by weight to 20 parts by weight, more preferably 0.05 parts by weight to 15 parts by weight, still more preferably 0.1 parts by weight to 10 parts by weight, even more preferably 0.2 parts by weight to 5 parts by weight, and particularly preferably 0.3 parts by weight to 3 parts by weight, based on 100 parts by weight of the resin particles.

In step (3), the aqueous dispersion of resin particles impregnated with the peroxide is heated to a temperature suited for decomposition of the peroxide. The heating temperature is preferably within a range of about 25° C. above and below the 1-hour half-life temperature exhibited by the peroxide described above (1-hour half-life temperature−25° C. to 1-hour half-life temperature+25° C.). Specifically, the heating temperature is preferably 30° C. to 140° C., more preferably 50° C. to 135° C., and still more preferably 60° C. to 130° C. According to the present method, since the resin (for example, PHA) can be crosslinked at a temperature lower than the melting temperature of the resin, deterioration of the resin due to heating during the crosslinking treatment can be avoided. It should be noted that the melting temperature of PHA is, for example, 50° C. to 210° C.

In the subsequent step (4), it is preferable to maintain the above-described heating temperature. As a result, the crosslinking reaction using the peroxide can be sufficiently advanced. The time for maintaining the heating temperature is not particularly limited, but is preferably 1 minute to 15 hours, and more preferably 1 hour to 10 hours.

After completion of the crosslinking reaction, by separating the crosslinked resin particles from the aqueous dispersion and removing water from the separated crosslinked resin particles, dried crosslinked resin particles can be obtained. A method for separating the crosslinked resin particles from the aqueous dispersion is not particularly limited, and for example, filtration, centrifugal separation, drying with heating, freeze drying, spray drying, or the like can be used. For example, when spray drying is used, dried crosslinked resin particles can be obtained directly from the aqueous dispersion. Also, by extruding the crosslinked resin particles by themselves after separating them from the aqueous dispersion, it is also possible to obtain the crosslinked resin particles in the form of pellets while completely removing the residual moisture. In addition, a coagulation step by the use of a coagulant and/or by pH adjustment may be carried out.

The amount of the crosslinked resin particles (B) in the present resin composition is preferably 1 part by weight or more and 60 parts by weight based on 100 parts by weight of the total of the poly(3-hydroxyalkanoate)-based copolymer (A), the crosslinked resin particles (B), and the poly(3-hydroxybutyrate) homopolymer (C). According to this configuration, the thermoplastic resin composition can provide a molded article excellent in impact resistance. The amount of the crosslinked resin particles (B) in the present resin composition may be 5 parts by weight or more, may be 7 parts by weight or more, may be 10 parts by weight or more, may be 15 parts by weight or more, may be 20 parts by weight or more, may be 25 parts by weight or more, or may be 30 parts by weight or more, based on 100 parts by weight of the total of the poly(3-hydroxyalkanoate)-based copolymer (A), the crosslinked resin particles (B), and the poly(3-hydroxybutyrate) homopolymer (C). The amount of the crosslinked resin particles (B) in the present resin composition is preferably 55 parts by weight or less, more preferably 53 parts by weight or less, and still more preferably 50 parts by weight or less, based on 100 parts by weight of the total of the poly(3-hydroxyalkanoate)-based copolymer (A), the crosslinked resin particles (B), and the poly(3-hydroxybutyrate) homopolymer (C). The amount of the crosslinked resin particles (B) in the present resin composition may be 45 parts by weight or less, may be 40 parts by weight or less, may be 30 parts by weight or less, may be 20 parts by weight or less, may be 15 parts by weight or less, may be 12 parts by weight or less, or may be 10 parts by weight or less, based on 100 parts by weight of the total of the poly(3-hydroxyalkanoate)-based copolymer (A), the crosslinked resin particles (B), and the poly(3-hydroxybutyrate) homopolymer (C).

### Poly(3-Hydroxyalkanoate)-Based Copolymer (A)

In the present resin composition, the poly(3-hydroxyalkanoate)-based copolymer (A) can also be referred to as a matrix resin. The poly(3-hydroxyalkanoate)-based copolymer (A) preferably has a gel fraction of less than 50%. It is preferable that the poly(3-hydroxyalkanoate)-based copolymer (A) is not crosslinked by the above-described peroxide used for the crosslinked resin particles (B), or by the above-described peroxide and polyfunctional compound, in the present resin composition.

The poly(3-hydroxyalkanoate)-based copolymer (A) contains a 3-hydroxyalkanoic acid repeating unit in an amount of 50 mol % or more, with the amount of repeating units being 100 mol %.

The poly(3-hydroxyalkanoate)-based copolymer (A) is a copolymer of the first 3-hydroxyalkanoic acid and another hydroxyalkanoic acid other than the first 3-hydroxyalkanoic acid, among the P3HA described in the section of (PHA) above. The poly(3-hydroxyalkanoate)-based copolymer (A) has a first 3-hydroxyalkanoic acid repeating unit and another hydroxyalkanoic acid repeating unit other than the first 3-hydroxyalkanoic acid repeating unit. As the first 3-hydroxyalkanoic acid repeating unit, the poly(3-hydroxyalkanoate)-based copolymer (A) may contain at least any one of the above-described repeating units contained in the P3HA. It is preferable that the 3-hydroxyalkanoic acid repeating unit is a 3-hydroxybutyric acid repeating unit.

The other hydroxyalkanoic acid repeating unit contained in the poly(3-hydroxyalkanoate)-based copolymer (A) may be any hydroxyalkanoic acid repeating unit other than the above-described at least first 3-hydroxyalkanoic acid repeating unit, and examples thereof include a 3-hydroxy-3-methylbutyric acid unit, a 3-hydroxyhexanoic acid repeating unit, a 4-hydroxybutyric acid repeating unit, a 3-hydroxyoctanoic acid repeating unit, and a 3-hydroxydecanoic acid repeating unit.

The poly(3-hydroxyalkanoate)-based copolymer (A) is preferably at least one selected from the group consisting of poly(3-hydroxybutyrate-co-3-hydroxyvalerate), poly(3-hydroxybutyrate-co-3-hydroxyhexanoate), poly(3-hydroxybutyrate-co-3-hydroxyvalerate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate), and is more preferably poly(3-hydroxybutyrate-co-3-hydroxyhexanoate).

As for the weight average molecular weight (Mw) of the poly(3-hydroxyalkanoate)-based copolymer (A), from the viewpoint of moldability and impact resistance, the poly(3-hydroxyalkanoate)-based copolymer (A) preferably has a weight average molecular weight of 100,000 or more and 1,000,000 or less, and more preferably 200,000 or more and 850,000 or less.

The weight average molecular weight of the poly(3-hydroxyalkanoate)-based copolymer (A) can be measured by gel permeation chromatography using a chloroform solution (HPLC GPC system manufactured by Shimadzu Corporation), and calculated in terms of polystyrene. As the column in the gel permeation chromatography, any column appropriate for measuring the weight average molecular weight may be used.

A method for producing the poly(3-hydroxyalkanoate)-based copolymer (A) is not particularly limited, and it may be a production method by chemical synthesis or a production method by microorganisms. Among these, a production method by microorganisms is preferable. The above-described method for producing PHA by microorganisms can be applied to the production method by microorganisms.

### Poly(3-Hydroxybutyrate) Homopolymer (C)

In the present resin composition, the poly(3-hydroxybutyrate) homopolymer (C) is included in the poly(3-hydroxyalkanoate)-based copolymer (A) serving as the matrix resin, and can also be referred to as a poly(3-hydroxyalkanoate)-based resin having higher crystallinity than the poly(3-hydroxyalkanoate)-based copolymer (A). The poly(3-hydroxybutyrate) homopolymer (C) preferably has a gel fraction of less than 50%. It is preferable that the poly(3-hydroxybutyrate) homopolymer (C) is not crosslinked by the above-described peroxide used for the crosslinked resin particles (B), or by the above-described peroxide and polyfunctional compound, in the present resin composition.

The poly(3-hydroxybutyrate) homopolymer (C) is a homopolymer of 3-hydroxybutyric acid, and by comprising the poly(3-hydroxybutyrate) homopolymer (C), the moldability of the present resin composition can be enhanced.

By comprising the poly(3-hydroxybutyrate) homopolymer (C), the present resin composition can enhance the moldability of a molded article even when, for example, it does not comprise a nucleating agent, which will be described later. The present resin composition exhibits the effect that, by not comprising a nucleating agent or by reducing the amount of the nucleating agent, the occurrence of bleed-out of the nucleating agent can be suppressed.

From the viewpoint of moldability and heat resistance, the weight average molecular weight (Mw) of the poly(3-hydroxybutyrate) homopolymer (C) is preferably 160,000 or more and 500,000 or less, and more preferably 200,000 or more and 400,000 or less.

The weight average molecular weight of the poly(3-hydroxybutyrate) homopolymer (C) can be measured, as in the case of the poly(3-hydroxyalkanoate)-based copolymer (A), by gel permeation chromatography using a chloroform solution (HPLC GPC system manufactured by Shimadzu Corporation).

Also, a method for producing the poly(3-hydroxybutyrate) homopolymer is not particularly limited, and similarly to the poly(3-hydroxyalkanoate)-based copolymer (A), it may be a production method by chemical synthesis or a production method by microorganisms. Among these, a production method by microorganisms is preferable, and the above-described method for producing PHA by microorganisms can be applied.

In the present resin composition, from the viewpoint of impact resistance and moldability, the weight ratio [(C)/(A)] of the poly(3-hydroxybutyrate) homopolymer (C) to the poly(3-hydroxyalkanoate)-based copolymer (A) is preferably 0.05 or more and 0.4 or less, and more preferably 0.1 or more and 0.3 or less.

A method for obtaining a blended product of the poly(3-hydroxyalkanoate)-based copolymer (A) and the poly(3-hydroxybutyrate) homopolymer (C) is not particularly limited. The blended product may be obtained by melt kneading two or more resins using an extruder, a kneader, a Banbury mixer, a roll, or the like, or the blended product may be obtained by dissolving two or more resins in a solvent, mixing, and drying.

The crosslinked resin particles (B) comprise biodegradable PHA, and the poly(3-hydroxyalkanoate)-based copolymer (A) and the poly(3-hydroxybutyrate) homopolymer (C) also have biodegradability. For this reason, there is an advantage that the entire thermoplastic resin composition and the entire molded article of the thermoplastic resin composition have high biodegradability. Therefore, one embodiment of the present invention can address the problem of plastic waste and is expected to be useful as an environmentally friendly thermoplastic resin composition. In addition, since the poly(3-hydroxyalkanoate)-based copolymer (A) and the poly(3-hydroxybutyrate) homopolymer (C) comprise biodegradable resins, the present resin composition and the molded article thereof can suppress soil pollution and/or marine pollution caused by disposal. As a result, the present invention is expected to contribute, for example, to achieving Sustainable Development Goals (SDGs) such as Goal 12 “Ensure sustainable consumption and production patterns” and/or Goal 14 “Conserve and sustainably use the oceans, seas and marine resources for sustainable development”.

In addition, when the crosslinked resin particles (B) comprise a resin produced from plant-derived raw materials, from the viewpoint of resource circulation, it is preferable that the poly(3-hydroxyalkanoate)-based copolymer (A) and the poly(3-hydroxybutyrate) homopolymer (C) also comprise resins produced from plant-derived raw materials, and it is more preferable that they are constituted only by resins produced from plant-derived raw materials.

### <Other Biodegradable Resin>

A case where the present resin composition comprise, as a matrix resin, a biodegradable resin other than the poly(3-hydroxyalkanoate)-based copolymer (A) and the poly(3-hydroxybutyrate) homopolymer (C) (hereinafter referred to as “other biodegradable resin” in some cases) will be described. Since the present resin composition and the molded article thereof can significantly benefit from the impact resistance improvement effect provided by the crosslinked resin particles (B), the present resin composition preferably comprises, as the other biodegradable resin, a polyester-based resin, more preferably comprises aliphatic polyester, and particularly preferably comprises PHA and/or polylactic acid. It should be noted that the other biodegradable resin, as with the poly(3-hydroxyalkanoate)-based copolymer (A) and the poly(3-hydroxybutyrate) homopolymer (C), preferably has a gel fraction of less than 50%. Also, it is preferable that the PHA used as the other biodegradable resin does not have a crosslinked structure.

The PHA that can be used as the other biodegradable resin is not particularly limited, and examples include polyglycolic acid, P3HA, and poly(4-hydroxyalkanoate)-based resins. As the PHA, one type may be used alone, or two or more types may be used in combination. As the PHA used as the other biodegradable resin, P3HA is particularly preferable.

A case where the crosslinked resin particles (B) comprise P3HA will be described. The P3HA that can be used as the other biodegradable resin is the same as the P3HA related to the crosslinked resin particles (B), and the various types of P3HA described above can be used. The P3HA contained in the crosslinked resin particles (B) may be a resin having the same compositional features as the P3HA contained in the other biodegradable resin, or may be a resin having different compositional features and/or physical properties. The other biodegradable resin P3HA is preferably a resin having different compositional features and/or physical properties from those of the P3HA contained in the crosslinked resin particles (B), and is more preferably a resin harder than the P3HA contained in the crosslinked resin particles (B).

The weight average molecular weight of the PHA used as the other biodegradable resin contained in the present resin composition is not particularly limited, but it is preferably 50,000 to 3,000,000, more preferably 100,000 to 2,000,000, and still more preferably 150,000 to 1,500,000. When the weight average molecular weight of the PHA is 50,000 or more, sufficient rigidity and/or strength can be obtained in the present resin composition and the molded article thereof. On the other hand, PHA having a weight average molecular weight of 3,000,000 or less has the advantage that the PHA can be easily produced, and/or has the advantage that it can be easily handled to achieve the object of one embodiment of the present invention.

The polylactic acid that can be used as the other biodegradable resin contained in the present resin composition may be a conventionally known polylactic acid. The polylactic acid may be crystalline polylactic acid, amorphous polylactic acid, or a mixture of crystalline polylactic acid and amorphous polylactic acid.

The polylactic acid may be a homopolymer of lactic acid or a copolymer of lactic acid and another monomer. Alternatively, it may be a blended product of a homopolymer of lactic acid and a copolymer of lactic acid and another monomer.

Examples of the other monomer include aliphatic hydroxycarboxylic acids other than lactic acid, aliphatic polyhydric alcohols, aliphatic polyvalent carboxylic acids, and polyfunctional polysaccharides.

A lactic acid raw material for producing the polylactic acid is not particularly limited either, and L-lactic acid, D-lactic acid, DL-lactic acid, or a mixture thereof, and L-lactide, D-lactide, meso-lactide, or a mixture thereof can be used. Lactic acid obtained by microbial fermentation from renewable plant-derived raw materials such as starch can be suitably used.

A method for producing the polylactic acid is not particularly limited, and a known method such as dehydration condensation method and ring-opening polymerization method can be applied.

The weight average molecular weight of the polylactic acid used as the other biodegradable resin contained in the present resin composition is not particularly limited, but it is preferably 50,000 to 1,000,000, more preferably 70,000 to 700,000, and still more preferably 100,000 to 400,000. When the weight average molecular weight of the polylactic acid is 50,000 or more, sufficient rigidity and/or strength can be obtained in the present resin composition and the molded article thereof. On the other hand, polylactic acid having a weight average molecular weight of 1,000,000 or less has the advantage that the polylactic acid can be easily produced, and/or has the advantage that it can be easily handled to achieve the object of one embodiment of the present invention.

The aspects of the PHA used as the other biodegradable resin contained in the present resin composition, other than those described above, are the same as those described in the section of (PHA) above, and thus the description thereof is incorporated herein by reference and not repeated here.

### <Other Resin Component>

The present resin composition may comprise another resin component to the extent that the effects of the present invention are not impaired. The other resin component is not particularly limited as long as it is a resin that can be melted by heating and then cooled and solidified to be molded into a desired shape. Specific examples thereof include polyolefin-based resins such as polyethylene and polypropylene; polyvinyl chloride; polystyrene; polyvinyl acetate; polyurethane; polytetrafluoroethylene; acrylic resins such as polymethyl methacrylate; AS resin; polyamide; polyacetal; polycarbonate; modified polyphenylene ether; polyester-based resins; and cyclic polyolefin. One of these other resin components may be used alone, or two or more thereof may be used in combination.

### <Nucleating Agent>

The present resin composition may further comprise a nucleating agent to the extent that the effects of the present invention are not impaired. By the present resin composition comprising a nucleating agent, when the thermoplastic resin is a crystalline resin, crystallization during molding can be promoted, thereby improving moldability, productivity, and other properties. When the present resin composition comprises a nucleating agent, there is also an advantage that a thermoplastic resin composition and a molded article thereof excellent in heat resistance or mechanical properties can be obtained.

The nucleating agent is not particularly limited, and conventionally known nucleating agents can be used. Examples of the nucleating agent include: inorganic substances such as talc, kaolinite, montmorillonite, mica, synthetic mica, clay, zeolite, silica, carbon black, graphite, boron nitride, zinc oxide, titanium oxide, tin oxide, calcium carbonate, magnesium carbonate, aluminum oxide, neodymium oxide, barium sulfate, sodium chloride, and metal phosphates; sugar alcohol compounds derived from natural products such as erythritol, pentaerythritol, galactitol, mannitol, and arabitol; polysaccharides such as chitin and chitosan; polyols such as aliphatic alcohols (polyols), polyvinyl alcohol, and polyethylene oxide; organic carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate, and sodium cyclohexanecarboxylate; organic sulfonic acid salts such as sodium p-toluenesulfonate and sodium sulfoisophthalate; carboxylic acid amides such as ethylenebisstearamide, ethylenebislauramide, palmitamide, hydroxystearamide, erucamide, and trimesic acid tris(t-butylamide); carboxylic acid esters such as lauric acid esters, palmitic acid esters, oleic acid esters, stearic acid esters, erucic acid esters, N-oleyl palmitate, N-oleyl oleate, N-oleyl stearate, N-stearyl oleate, N-stearyl stearate, N-stearyl erucate, methylene bisstearate, ethylene bislaurate, ethylene bisscaprate, ethylene bisoleate, ethylene bisstearate, ethylene biserucate, ethylene bisisostearate, butylene bisstearate, and p-xylylene bisstearate; dicarboxylic acid derivatives such as dimethyl adipate, dibutyl adipate, diisodecyl adipate, and dibutyl sebacate; cyclic compounds having a functional group C═O and one or more functional groups selected from NH, S, and O in the molecule, such as indigo, quinacridone, and quinacridone magenta; sorbitol-based derivatives such as bisbenzylidene sorbitol and bis(p-methylbenzylidene) sorbitol; compounds containing a nitrogen-containing heteroaromatic nucleus, such as pyridine, triazine, and imidazole; phosphoric acid ester compounds, bisamides of higher fatty acids, and metal salts of higher fatty acids; branched polylactic acid; and low molecular weight poly-3-hydroxybutyrate. One of these nucleating agents may be used alone, or two or more thereof may be used in combination.

The amount of the nucleating agent is not particularly limited as long as it can promote crystallization of the resins contained in the thermoplastic resin composition. The amount of the nucleating agent is preferably 0.05 parts by weight to 12.00 parts by weight, more preferably 0.10 parts by weight to 10.00 parts by weight, and still more preferably 0.50 parts by weight to 8.00 parts by weight, based on 100 parts by weight of the total of the poly(3-hydroxyalkanoate)-based copolymer (A), the crosslinked resin particles (B), and the poly(3-hydroxybutyrate) homopolymer (C). When the amount of the nucleating agent is within the above range, the effect as a nucleating agent can be obtained while suppressing a decrease in viscosity during molding and a decrease in physical properties of a molded article.

### <Lubricant>

The present resin composition may further comprise a lubricant. When the thermoplastic resin composition contains a lubricant, the surface smoothness of the resulting molded article can be improved. The lubricant is not particularly limited. Examples of the lubricant include, but are not limited to, fatty acid metal salts such as magnesium stearate and calcium stearate; fatty acid amides such as behenamide, stearamide, erucamide, oleamide, methylenebis(stearamide), and ethylenebis(stearamide); polyethylene wax; oxidized polyester wax; glycerin mono-fatty acid esters such as glycerin monostearate, glycerin monobehenate, and glycerin monolaurate; organic acid monoglycerides such as succinic acid saturated fatty acid monoglycerides; sorbitan fatty acid esters such as sorbitan behenate, sorbitan stearate, and sorbitan laurate; polyglycerin fatty acid esters such as diglycerin stearate, diglycerin laurate, tetraglycerin stearate, tetraglycerin laurate, decaglycerin stearate, and decaglycerin laurate; and higher alcohol fatty acid esters such as stearyl stearate. One of these lubricants may be used alone, or two or more thereof may be used in combination.

The amount of the lubricant (when a plurality of lubricants are used, the total amount thereof) is not particularly limited as long as lubricity can be imparted to the molded article. The amount of the lubricant is preferably 0.01 parts by weight to 20.00 parts by weight, more preferably 0.05 parts by weight to 10.00 parts by weight, still more preferably 0.10 parts by weight to 10.00 parts by weight, even more preferably 0.20 parts by weight to 5.00 parts by weight, and particularly preferably 0.30 parts by weight to 4.00 parts by weight, based on 100 parts by weight of the total of the poly(3-hydroxyalkanoate)-based copolymer (A), the crosslinked resin particles (B), and the poly(3-hydroxybutyrate) homopolymer (C). When the amount of the lubricant is within the above range, the effect as a lubricant can be obtained while avoiding bleed-out of the lubricant to the molded article surface.

### <Other Components>

The present resin composition can contain other components such as a plasticizer; an organic filler; an inorganic filler; an antioxidant; a hydrolysis inhibitor; an ultraviolet absorber; a colorant such as a dye or a pigment; and an antistatic agent to the extent that the functions of the resulting molded article are not impaired.

The plasticizer is not particularly limited. Examples of the plasticizer may include polyester-based plasticizers such as polypropylene glycol sebacate; aliphatic dibasic acid ester-based plasticizers such as di-1-butyl adipate, di-n-butyl sebacate, and di-2-ethylhexyl azelate; glycerin-based plasticizers such as glycerin diacetomonolaurate, glycerin diacetomonocaprylate, and glycerin diacetomonodecanoate; polyvalent carboxylic acid ester-based plasticizers such as tri-2-ethylhexyl acetylcitrate and tributyl acetylcitrate; polyalkylene glycol-based plasticizers such as polyethylene glycol, polypropylene glycol, poly(ethylene oxide-propylene oxide) block and/or random copolymers, and polytetramethylene glycol; phosphate ester-based plasticizers such as diphenyl 2-ethylhexyl phosphate and diphenyl octyl phosphate; epoxy-based plasticizers such as epoxidized soybean oil and epoxidized linseed oil fatty acid butyl ester; and castor oil-based plasticizers such as castor oil fatty acid esters, methyl ricinoleate, ethyl ricinoleate, isopropyl ricinoleate, butyl ricinoleate, ethylene glycol monoricinoleate, propylene glycol monoricinoleate, trimethylolpropane monoricinoleate, sorbitan monoricinoleate, castor oil fatty acid polyethylene glycol esters, castor oil ethylene oxide adducts, castor oil-based polyols, castor oil-based triols, and castor oil-based diols. One of these plasticizers may be used alone, or two or more thereof may be used in combination.

The organic filler is not particularly limited. Examples of the organic filler include fillers constituted by materials derived from natural sources such as woody materials (for example, wood chips, wood flour, sawdust, and the like), rice husks, rice flour, starch, corn starch, rice straw, wheat straw, and natural rubber; organic fibers such as plant-based natural fibers, animal-based natural fibers, and synthetic fibers; and fillers constituted by materials of synthetic resins such as polyester, polyacrylic, polyamide, nylon, polyethylene, polyolefin, polyvinyl alcohol, polyvinyl chloride, polyurethane, polyacetal, aramid, PBO (poly-p-phenylene benzobisoxazole), polyphenylene sulfide, acetyl cellulose, polybenzazole, polyarylate, polyvinyl acetate, and synthetic rubber.

The plant-based natural fibers are not particularly limited. Examples of the plant-based natural fibers include kenaf fibers, abaca fibers, bamboo fibers, jute fibers, hemp fibers, linen fibers, henequen (sisal hemp), ramie fibers, hemp, cotton, banana fibers, coconut fibers, coco, palm, kozo, mitsumata, and bagasse. Also included are regenerated fibers processed from plant fibers, such as pulp, cellulose fibers, and rayon. Examples of the animal-based natural fibers include wool, silk, cashmere, and mohair.

The inorganic filler is not particularly limited. Examples of the inorganic filler include silica-based inorganic fillers (for example, quartz, fumed silica, anhydrous silicic acid, fused silica, crystalline silica, amorphous silica, fillers formed by condensation of alkoxysilanes, ultrafine amorphous silica, and the like), alumina, zircon, iron oxide, zinc oxide, titanium oxide, silicon nitride, boron nitride, aluminum nitride, silicon carbide, glass, silicone rubber, silicone resin, titanium oxide, carbon fibers, mica, graphite, carbon black, ferrite, graphite, diatomaceous earth, kaolin, clay, talc, calcium carbonate, manganese carbonate, magnesium carbonate, barium sulfate, and silver powder. These inorganic fillers may be surface-treated in order to improve dispersibility in the resin composition. Also, one of these inorganic fillers may be used alone, or two or more thereof may be used in combination.

The antioxidant is not particularly limited. Examples of the antioxidant include phenol-based antioxidants, phosphorus-based antioxidants, and sulfur-based antioxidants. One of these antioxidants may be used alone, or two or more thereof may be used in combination.

The hydrolysis inhibitor is not particularly limited. Examples of the hydrolysis inhibitor include carbodiimide compounds, epoxy compounds, isocyanate compounds, and oxazoline compounds. One of these hydrolysis inhibitors may be used alone, or two or more thereof may be used in combination.

The ultraviolet absorber is not particularly limited. Examples of the ultraviolet absorber include benzophenone-based compounds, benzotriazole-based compounds, triazine-based compounds, salicylic acid-based compounds, cyanoacrylate-based compounds, and nickel complex salt-based compounds. One of these ultraviolet absorbers may be used alone, or two or more thereof may be used in combination.

The colorant such as a pigment or a dye is not particularly limited. Examples of the colorant include inorganic colorants such as titanium oxide, calcium carbonate, chromium oxide, cuprous oxide, calcium silicate, iron oxide, carbon black, graphite, titanium yellow, and cobalt blue; soluble azo pigments such as lake red, lithol red, and brilliant carmine; insoluble azo pigments such as dinitrian orange and fast yellow; phthalocyanine pigments such as monochlorophthalocyanine blue, polychlorophthalocyanine blue, and polybromophthalocyanine green; condensed polycyclic pigments such as indigo blue, perylene red, isoindolinone yellow, and quinacridone red; and dyes such as Oracet Yellow. One of these colorants may be used alone, or two or more thereof may be used in combination.

The antistatic agent is not particularly limited. Examples of the antistatic agent include low molecular weight antistatic agents such as fatty acid ester compounds, aliphatic ethanolamine compounds, and aliphatic ethanolamide compounds; and polymeric antistatic agents. One of these antistatic agents may be used alone, or two or more thereof may be used in combination.

The present resin composition can also contain a catalyst deactivator (such as a hindered phenol-based compound, a thioether-based compound, a vitamin-based compound, a triazole-based compound, a polyvalent amine-based compound, a hydrazine derivative-based compound, or a phosphorus-based compound), a mold release agent (such as montanic acid or a salt thereof, an ester thereof, a half-ester thereof, stearyl alcohol, stearamide, or polyethylene wax), a coloration inhibitor (such as a phosphite or a hypophosphite), a silane coupling agent (such as an epoxy silane coupling agent, an amino silane coupling agent, a (meth)acrylic silane coupling agent, or an isocyanate silane coupling agent), a flame retardant (such as red phosphorus, a phosphate ester, brominated polystyrene, brominated polyphenylene ether, brominated polycarbonate, aluminum hydroxide, magnesium hydroxide, melamine or cyanuric acid or a salt thereof, or a silicon compound), a conductive agent (such as carbon black), a sliding property improver (such as graphite or a fluororesin), an epoxy compound (such as a glycidyl ether compound, a glycidyl ester compound, or a polymeric compound obtained by grafting or copolymerizing a glycidyl compound), an acid anhydride compound (such as maleic anhydride, succinic anhydride, or a polymeric compound obtained by grafting or copolymerizing an acid anhydride), a carbodiimide compound (such as N,N′-di-2,6-diisopropylphenyl carbodiimide, 2,6,2′,6′-tetraisopropyldiphenyl carbodiimide, or polycarbodiimide), or the like.

The amount of each of the other components described above is not particularly limited as long as the effects of one embodiment of the present invention can be achieved, and may be set as appropriate by those skilled in the art.

### <Method for Producing Thermoplastic Resin Composition>

The present resin composition can be produced by a known method. Specific examples thereof include a method in which the poly(3-hydroxyalkanoate)-based copolymer (A), the crosslinked resin particles (B), and the poly(3-hydroxybutyrate) homopolymer (C), as well as a lubricant and other components as optional components, are melt kneaded using an extruder, a kneader, a Banbury mixer, a kneading roll, or the like. When melt kneading is performed, it is preferable to carry out mixing while paying attention to a decrease in molecular weight due to thermal decomposition. Alternatively, the thermoplastic resin composition can also be produced by dissolving all raw materials (components) in a soluble solvent and then removing the solvent.

When producing the thermoplastic resin composition by melt kneading, each component may be individually fed into an extruder or the like, or a mixture obtained by premixing the respective components may be fed into an extruder or the like. For example, after mixing an aqueous dispersion of the thermoplastic resin with an aqueous dispersion of the crosslinked resin particles, the resulting mixed solution may be dried in a dryer to obtain a mixed powder, and the mixed powder may be fed into an extruder or the like.

When melt kneading is performed using an extruder, the obtained thermoplastic resin composition may be processed into particle shapes such as bar-shaped, cylindrical, elliptic cylindrical, spherical, cubic, or rectangular parallelepiped by extruding the thermoplastic resin composition from the extruder in a strand form and then cutting the extruded strands.

The resin temperature during melt kneading cannot be unconditionally specified because it depends on the melting point, melt viscosity, and other properties of the resin to be used. From the viewpoint of uniformly dispersing the crosslinked resin particles in the thermoplastic resin while avoiding thermal decomposition of the thermoplastic resin, the resin temperature is preferably 140° C. to 250° C., more preferably 150° C. to 230° C., and still more preferably 160° C. to 210° C.

### <Molded Article and Method for Producing the Same>

In one embodiment of the present invention, there is provided a molded article formed by molding the present resin composition. The method for molding the thermoplastic resin composition is not particularly limited, and commonly used molding methods can be applied. Specific examples of the molding method include inflation film molding, extrusion blow molding, injection blow molding, extrusion molding, calender molding, vacuum molding, and injection molding. The molded article formed by molding the thermoplastic resin composition may also be referred to as a molded article comprising the thermoplastic resin composition.

By carrying out the above-described molding method using the present resin composition, a molded article excellent in impact resistance, specifically a film molded article, a sheet molded article, a blow molded article, an extrusion molded article, a vacuum molded article, or an injection molded article, can be produced with good productivity. In the present specification, the term “film molded article” conforms to JIS 20108:2012 and specifically refers to a thin film-shaped body having a thickness of less than 0.25 mm. In the present specification, the term “sheet molded article” conforms to JIS 20108:2012 and specifically refers to a thin plate-shaped body having a thickness of 0.25 mm or more.

### <Resin Tube and Method for Producing the Same>

The molded article molded from the present resin composition may be a resin tube. The resin tube refers to an elongated cylindrical molded product that has a substantially constant wall thickness, is constituted by a wall having a substantially circular cross-sectional shape, and has a hollow interior. The resin tube can be used, for example, as a straw or a pipe, but its applications are not limited thereto.

The cross-sectional shape of the resin tube only needs to be substantially circular, and from the viewpoint of usability as a straw or a pipe, it is preferable that the shape is closer to a true circle. Accordingly, the degree of flattening of the cross-sectional shape of the resin tube [100×(maximum outer diameter−minimum outer diameter)/maximum outer diameter] is preferably 10% or less, more preferably 8% or less, still more preferably 5% or less, and even more preferably 3% or less. It should be noted that a degree of flattening of 0% means that the cross-sectional shape is a true circle.

The wall thickness of the resin tube when used as a straw is preferably 0.01 mm or more and 0.6 mm or less, more preferably 0.05 mm or more and 0.5 mm or less, and still more preferably 0.1 mm or more and 0.4 mm or less. As a result, the resin tube does not collapse due to suction when drinking a beverage and has moderate flexibility, thereby being resistant to cracking, and can achieve both usability in that it is less likely to cause injury when a fingertip or the like contacts it, and biodegradability such that, after disposal, it rapidly undergoes biodegradation even in seawater, for example.

Also, the outer diameter of the resin tube when used as a straw is not particularly limited, but from the viewpoint of ease of use when drinking a beverage, it is preferably 2 to 10 mm, more preferably 4 to 8 mm, and still more preferably 5 to 7 mm. The length of the resin tube when used as a straw is not particularly limited, and from the viewpoint of ease of use when drinking a beverage, it is preferably 50 to 350 mm, more preferably 70 to 300 mm, and still more preferably 90 to 270 mm.

The resin tube when used as a straw may be a tube that has not been subjected to secondary processing, or may be a tube that has been subjected to secondary processing such as formation of a stopper portion or formation of a bellows portion.

The wall thickness of the resin tube when used as a pipe can be set as appropriate by those skilled in the art, but it is preferably 0.7 mm or more and 10 mm or less, and more preferably 1 mm or more and 8 mm or less. As a result, the resin tube can be suitably used in aquaculture or fishing of marine products.

The resin tube used as a straw or a pipe can be produced by a known method. For example, it can be produced by melting a blended product of the present resin composition and additives in an extruder, extruding the melted blend from an annular die connected to the outlet of the extruder, and introducing the extruded product into water to solidify it, thereby forming the product into a tubular shape.

When secondary processing is performed on the resin tube, the secondary processing may be carried out at ordinary temperature or under heating. Secondary processing involving heating can be suitably carried out on the resin tube. The heating temperature during the secondary processing can be set as appropriate, and it may be, for example, about 100 to 150° C.

A molded article comprising the present resin composition can be suitably used in agriculture, fisheries, forestry, horticulture, medicine, sanitary products, the food industry, clothing, non-clothing applications, packaging, automobiles, building materials, and other fields.

### SUMMARY

One embodiment of the present invention may include the following configurations.

[1] A thermoplastic resin composition comprising: a poly(3-hydroxyalkanoate)-based copolymer (A); crosslinked resin particles (B); and a poly(3-hydroxybutyrate) homopolymer (C), wherein the crosslinked resin particles (B) comprise a polyhydroxyalkanoate-based resin and have a gel fraction of 50% or more, and a weight ratio [(C)/(A)] of the poly(3-hydroxybutyrate) homopolymer (C) to the poly(3-hydroxyalkanoate)-based copolymer (A) is 0.05 or more and 0.4 or less.

[2] The thermoplastic resin composition according to [1], wherein the poly(3-hydroxyalkanoate)-based copolymer (A) has a weight average molecular weight of 100,000 or more and 1,000,000 or less.

[3] The thermoplastic resin composition according to [1] or [2], wherein the poly(3-hydroxybutyrate) homopolymer (C) has a weight average molecular weight of 160,000 or more and 500,000 or less.

[4] The thermoplastic resin composition according to any one of [1] to [3], wherein the poly(3-hydroxyalkanoate)-based copolymer (A) is at least one selected from the group consisting of poly(3-hydroxybutyrate-co-3-hydroxyvalerate), poly(3-hydroxybutyrate-co-3-hydroxyhexanoate), poly(3-hydroxybutyrate-co-3-hydroxyvalerate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

[5] The thermoplastic resin composition according to any one of [1] to [4], wherein the poly(3-hydroxyalkanoate)-based copolymer (A) is poly(3-hydroxybutyrate-co-3-hydroxyhexanoate).

[6] The thermoplastic resin composition according to any one of [1] to [5], comprising 1 part by weight or more and 60 parts by weight or less of the crosslinked resin particles (B) based on 100 parts by weight of a total amount [(A)+(B)+(C)] of the poly(3-hydroxyalkanoate)-based copolymer (A), the crosslinked resin particles (B), and the poly(3-hydroxybutyrate) homopolymer (C).

[7] The thermoplastic resin composition according to any one of [1] to [6], wherein the crosslinked resin particles (B) have a volume average particle diameter of 0.1 μm or more and 10.00 μm or less.

[8] The thermoplastic resin composition according to any one of [1] to [7], wherein the crosslinked resin particles (B) are those crosslinked using a peroxide.

[9] The thermoplastic resin composition according to [8], wherein the crosslinked resin particles (B) are those crosslinked in the presence of the peroxide and a polyfunctional compound.

[10] The thermoplastic resin composition according to any one of [1] to [9], wherein a proportion of the polyhydroxyalkanoate-based resin in 100% by weight of the crosslinked resin particles (B) is 80% by weight or more.

[11] A molded article comprising the thermoplastic resin composition according to any one of [1] to [10].

[12] The molded article according to [11], which is a sheet molded product, a film molded product, a blow molded product, an extrusion molded product, a vacuum molded product, or an injection molded product.

[13] The molded article according to [11], which is a resin tube.

### EXAMPLES

Examples are shown below to describe one embodiment of the present invention more specifically; however, the present invention is not limited in any way to these Examples.

### [1] Measurement Conditions

### 1-1. Weight Average Molecular Weight

The resin to be measured was added to chloroform, and the resulting mixture was heated in a warm water bath at 60° C. for 30 minutes. The obtained mixture (chloroform-dissolved product) was filtered through a PTFE disposable filter having a pore size of 0.45 μm. Thereafter, using the obtained filtrate, GPC measurement was performed under the following conditions to determine the weight average molecular weight.
GPC measurement apparatus: High performance liquid chromatograph 20A system manufactured by Shimadzu Corporation
Columns: K-G 4A (one column) and K-806M (two columns) manufactured by Showa Denko K.K.
Sample concentration: 1 mg/ml
Eluent: chloroform solution
Eluent flow rate: 1.0 ml/min
Sample injection volume: 100 μL
Analysis time: 30 minutes
Standard sample: standard polystyrene.

### 1-2. Volume Average Particle Diameter

The volume average particle diameter of the crosslinked resin particles (B) was measured using an aqueous dispersion of the crosslinked resin particles (B) as a sample. As a measurement apparatus, Microtrac MT3300EXII manufactured by Nikkiso Co., Ltd. was used. Specifically, using the above-described apparatus, the particle diameter and volume of each crosslinked resin particle in the aqueous dispersion of the crosslinked resin particles were measured, and based on the results obtained by the measurement, the volume average particle diameter was calculated in accordance with the above-described Expression (1), that is, Expression (2).

### 1-3. Gel Fraction

A dried product of the crosslinked resin particles (B) was added to chloroform so as to achieve a concentration of 0.7% by weight, and the resulting mixture was held at 60° C. for 630 minutes to obtain a chloroform solution. Thereafter, the chloroform solution was allowed to stand at room temperature for 3 hours, and the chloroform solution was then filtered through a membrane filter having a pore size of 0.45 μm. Filtration was performed while sufficiently washing the inside of the container and the filter by pouring chloroform thereover a plurality of times, thereby preventing loss. The gel remaining on the filter was dried, and the weight thereof together with the filter was measured. The gel fraction was calculated according to the following expression:

$$Expression : Gel fraction = \{ ( Weight of the filter including the dried gel - Weight of the filter alone ) / Weight of the crosslinked resin particles ( B ) used for the measurement \} \times 100 ( \% ) .$$

### 1-4. Measurement of Monomer Composition Ratio

The monomer composition ratio to be measured was determined as follows. To about 20 mg of a polymer (for example, P3HB3HH), 1 mL of a concentrated sulfuric acid (98%)-methanol mixed solution (15:85) and 1 mL of chloroform were added, and the mixture was placed in a sealed container and tightly sealed. The mixed solution in the container was heated at 100° C. for 140 minutes to obtain a methyl ester solution containing decomposition products of the polymer (for example, P3HB3HH). After cooling the solution, 0.5 mL of deionized water was added to the solution and mixed well. Thereafter, the obtained mixed solution was allowed to stand until an aqueous layer and an organic layer in the mixed solution were separated. Then, the organic layer was collected, and the compositional features of monomer units in the decomposition products of the polymer (for example, P3HB3HH) in the collected organic layer were analyzed by capillary gas chromatography. From the obtained peak areas, the ratio of a comonomer (for example, 3-hydroxyhexanoate) was calculated.

### 1-5. Method for Evaluating Tube Moldability

The cylinder temperature and the die temperature of a φ50 mm single screw extruder to which an annular die (outer diameter: 15 mm and inner diameter: 13.5 mm) was connected were each set to 150° C. Resin composition pellets were fed into the single screw extruder, and the resin composition was extruded in a tubular form from the annular die. The extruded tube was passed through a water bath at 40° C. located 100 mm away from the annular die, and then taken up at a molding speed of 60 m/min. By performing such an operation for 5 minutes, a resin tube having an outer diameter of 6 mm, a wall thickness of 0.2 mm, and a length of 200 mm was continuously produced for 5 minutes. At this time, the moldability of the resin tube was evaluated. In addition, after evaluating the moldability of the resin tube for 5 minutes, the molding speed was subsequently accelerated from 60 m/min to 65 m/min, and the resin tube was taken up at a molding speed of 65 m/min for 5 minutes. At this time, the moldability of the resin tube was evaluated. The evaluation criteria for tube moldability are as shown below.

### <Evaluation Criteria>

Good: Continuous molding can be performed for 5 minutes or more at a predetermined molding speed without occurrence of cutting defects. Fair: Cutting defects occur, but continuous molding can be performed for 5 minutes or more at a predetermined molding speed.

Poor: Continuous molding becomes impossible within less than 5 minutes at a predetermined molding speed.

### 1-6. Evaluation of Impact Resistance of Resin Tube

As an evaluation of the impact resistance of the resin tube, the 50% fracture energy was evaluated. The produced resin tube was cut to a length of 40 mm and used as a test specimen without being slit open. A plate was produced by laying a rubber sheet having a thickness of 2 mm on a SUS plate having a thickness of 3 mm. The test specimen was placed on the plate, and a weight having an arbitrary heaviness was freely dropped from an arbitrary height. Based on the fracture results at that time, the drop height at which 50% of the test specimen was fractured was identified as a 50% impact fracture height H, and the 50% fracture energy was calculated therefrom. The shape of the weight was a rectangular parallelepiped, and the weight was dropped such that the straw and the weight came into contact in parallel.

$$50 \% fracture energy ( J ) = weight load ( kg ) \times gravitational acceleration ( 9.8 m / {s}^{2} ) \times 50 \% impact fracture height H ( cm )$$

### [2] Evaluation of Thermoplastic Resin Composition

### 2-1. Poly(3-Hydroxyalkanoate)-Based Copolymer (A)

### Production Example 1

P3HB3HH-6: (3-hydroxybutyrate-co-3-hydroxyhexanoate): the compositional features of repeating units were (3-hydroxybutyrate)/(3-hydroxyhexanoate)=94/6 (mol/mol), and the weight average molecular weight was 600,000.

P3HB3HH-6 was produced according to the method described in International Publication No. WO 2008/010296.

### Production Example 2

P3HB3HH-11: (3-hydroxybutyrate-co-3-hydroxyhexanoate): the compositional features of repeating units were (3-hydroxybutyrate)/(3-hydroxyhexanoate)=89/11 (mol/mol), and the weight average molecular weight was 600,000.

P3HB3HH-11 was produced according to the method described in International Publication No. WO 2008/010296.

### Production Example 3

P3HB: poly(3-hydroxybutyrate): the weight average molecular weight was 350,000.

P3HB was produced according to the method described in Comparative Example 1 of International Publication No. WO 2004/041936.

### 2-2. Crosslinked Resin Particles (B)

As the crosslinked resin particles (B), crosslinked resin particles produced by the following procedure using the crosslinked resin particle raw materials described below were used.

### 2-1-1. Crosslinked Resin Particle Raw Materials

Uncrosslinked polyhydroxyalkanoate-based resin: P3HB3HH-28 (3-hydroxybutyrate-co-3-hydroxyhexanoate): the compositional features of repeating units were (3-hydroxybutyrate)/(3-hydroxyhexanoate)=72/28 (mol/mol), and the weight average molecular weight was 700,000. P3HB3HH-28 was produced according to the method described in Example 9 of International Publication No. WO 2019/142845.
Di-sec-butyl peroxydicarbonate (“Luperox® 225” manufactured by ARKEMA Yoshitomi, Ltd., 1-hour half-life temperature: 69° C.).

Polyfunctional compound: triallyl isocyanurate.

### 2-2-2. Method for Producing Crosslinked Resin Particles (B)

Crosslinked resin particles of Production Example 4 were produced by the procedure described below.

Into an autoclave equipped with a stirrer, a baffle, a nitrogen inlet/outlet, and a thermometer were added an aqueous dispersion in which P3HB3HH-28 as the polyhydroxyalkanoate-based resin was dispersed in water (100 parts by weight in terms of solid content), 200 parts by weight of deionized water, 2 parts by weight of the peroxide, 2 parts by weight of dioctyl sodium sulfosuccinate, and 0.5 parts by weight of the polyfunctional compound, to prepare an aqueous dispersion. Stirring of the obtained aqueous dispersion was started at room temperature, and at the same time, the inside of the autoclave was purged with nitrogen. Thereafter, the aqueous dispersion in the autoclave was stirred at room temperature (20 to 25° C.) for 1 hour, thereby impregnating the interior of P3HB3HH-28 with the peroxide and the polyfunctional compound.

Thereafter, the temperature of the aqueous dispersion was raised to 75° C., which is a reaction temperature as a crosslinking condition. After reaching the reaction temperature, the aqueous dispersion was reacted (held) at that temperature for 3.5 hours, thereby obtaining an aqueous dispersion in which the crosslinked resin particles (B) were dispersed in water.

After adjusting the pH of the aqueous dispersion, the aqueous dispersion was dried in an oven to obtain solidified crosslinked resin particles.

With respect to the obtained crosslinked resin particles, as a result of measuring the volume average particle diameter and the gel fraction by the above-described methods, the volume average particle diameter was 1.7 μm, and the gel fraction was 95%.

### 2-3. Raw Materials for Thermoplastic Resin Composition

### 2-3-1. Poly(3-Hydroxyalkanoate)-Based Copolymer (A)

P3HB3HH-6 of Production Example 1
P3HB3HH-11 of Production Example 2

### 2-3-2. Crosslinked Resin Particles (B)

Crosslinked resin particles (B) of Production Example 4

### 2-3-3. Poly(3-Hydroxybutyrate) Homopolymer (C)

P3HB of Production Example 3
   Poly(3-hydroxybutyrate) Homopolymer (C)

### 2-3-2. Crosslinked Resin Particles (B)

Crosslinked resin particles (B) of Production Example 4

### 2-3-3. Plasticizer

Glycerin diacetomonolaurate (manufactured by Riken Vitamin Co., Ltd.: BIOCIZER)

### 2-3-4. Lubricant

Lubricant-1: behenamide: BNT22H manufactured by Nippon Fine Chemical Co., Ltd.
Lubricant-2: erucamide: Neutron-S manufactured by Nippon Fine Chemical Co., Ltd.

### 2-4-1. Method for Producing Thermoplastic Resin Composition

### Example 1

31.5 parts by weight of P3HB3HH-6, 31.5 parts by weight of P3HB3HH-11, 7 parts by weight of P3HB, 1 part by weight of Lubricant-1, and 0.5 parts by weight of Lubricant-2 were blended. To the obtained blended product, 30 parts by weight of the crosslinked resin particles (B), in terms of solid content, were added and further blended to obtain a resin mixture.

The obtained resin mixture was fed into a φ26 mm co-rotating twin screw extruder in which the cylinder temperature and the die temperature were each set to 150° C., and was extruded. The extruded resin material was passed through a water bath filled with hot water at 40° C. to solidify strands, and was cut with a pelletizer, thereby obtaining thermoplastic resin composition pellets.

### 2-4-2. Method for Producing Resin Tube

The cylinder temperature and the die temperature of a φ50 mm single screw extruder to which an annular die (outer diameter: 15 mm and inner diameter: 13.5 mm) was connected were each set to 150° C., and the resin composition pellets were fed and extruded in a tubular form. The extruded tube was passed through a water bath at 40° C. installed 100 mm away from the annular die, and the tube that passed through the water bath was taken up at a molding speed of 60 m/min, thereby obtaining a resin tube having an outer diameter of 6 mm, a wall thickness of 0.2 mm, and a length of 200 mm. During production of the resin tube, the moldability of the resin tube was evaluated by the above-described method for evaluating tube moldability.

### Examples 2 to 5 and Comparative Examples 1 to 4

Resin composition pellets were produced in the same manner as in Example 1, except that the formulation was changed as shown in Table 1, and evaluations were carried out in the same manner as in Example 1. The results are summarized in Table 1.

TABLE 1

| Resin composition (parts by | | Example | | | | | Comparative Example | | | |
|---|---|---|---|---|---|---|---|---|---|---|
| weight) | | 1 | 2 | 3 | 4 | 5 | 1 | 2 | 3 | 4 |
| Copolymer | P3HB3HH-6 | 31.5 | 29 | 27 | 35 | 27.5 | 35 | 40 | 34.5 | 22.5 |
| (A) | P3HB3HH-11 | 31.5 | 29 | 27 | 35 | 27.5 | 35 | 40 | 34.5 | 22.5 |
| Homopolymer | P3HB | 7 | 12 | 16 | 15 | 10 | — | 20 | 1 | 25 |
| (C) | | | | | | | | | | |
| Crosslinked resin particles (B) | | 30 | 30 | 30 | 30 | 15 | 45 | — | 30 | 30 |
| Resin | (C)/(A) | 0.11 | 0.21 | 0.3 | 0.21 | 0.18 | — | 0.2 | 0.014 | 0.56 |
| composition | | | | | | | | | | |
| ratio | | | | | | | | | | |
| Pentaerythritol | | — | — | — | — | — | — | — | — | — |
| Additive | Lubricant-1 | 1 | 1 | 1 | 1 | 1 | 1 | 1 | 1 | 1 |
| | Lubricant-2 | 0.5 | 0.5 | 0.5 | 0.5 | 0.5 | 0.5 | 0.5 | 0.5 | 0.5 |
| Moldability | Molding speed | Good | Good | Good | Good | Good | Fair | Good | Fair | Good |
| | 60 m/min | | | | | | | | | |
| | Molding speed | Fair | Good | Good | Good | Good | Poor | Good | Poor | Good |
| | 65 m/min | | | | | | | | | |
| Impact | 50% fracture | 0.41 | 0.33 | 0.28 | 0.25 | 0.49 | 0.3 | 0.13 | 0.32 | 0.1 |
| resistance | energy (J) | | | | | | | | | |

From Table 1, the following can be understood. The thermoplastic resin compositions of Examples 1 to 5 could be molded at high speeds of 60 m/min and 65 m/min to form resin tubes (molded articles). Each of the resin tubes of Examples 1 to 5 had a 50% fracture energy of 0.2 J or more and exhibited good impact resistance.

On the other hand, the resin tube of Comparative Example 1 exhibited good impact resistance because it contained the crosslinked resin particles; however, since it did not contain P3HB (the homopolymer (C)), the thermoplastic resin composition of Comparative Example 1 exhibited insufficient moldability at a high speed. Also, in Comparative Example 2, the thermoplastic resin composition could be molded at high speeds because it contained P3HB, but since it did not contain the crosslinked resin particles, the obtained resin tube (molded article) exhibited insufficient impact resistance.

The resin tube of Comparative Example 3 had a weight ratio [(C)/(A)] in the thermoplastic resin composition of 0.014, which is smaller than 0.05; therefore, the resin tube exhibited good impact resistance but insufficient moldability at a high speed. Also, in Comparative Example 4, the thermoplastic resin composition had a weight ratio [(C)/(A)] of 0.56, which is larger than 0.4; as a result, moldability at high speeds was achievable, but the impact resistance of the resin tube (molded article) was insufficient.

### INDUSTRIAL APPLICABILITY

According to one embodiment of the present invention, there can be provided a novel thermoplastic resin composition capable of providing a molded article excellent in impact resistance. Therefore, one embodiment of the present invention can be suitably used in agriculture, fisheries, forestry, horticulture, medicine, sanitary products, the food industry, clothing, non-clothing applications, packaging, automobiles, building materials, and other fields.

1. A thermoplastic resin composition comprising:
a poly(3-hydroxyalkanoate)-based copolymer (A);
crosslinked resin particles (B); and
a poly(3-hydroxybutyrate) homopolymer (C),
wherein the crosslinked resin particles (B) comprise a polyhydroxyalkanoate-based resin and have a gel fraction of at least 50%, and
a weight ratio [(C)/(A)] of the poly(3-hydroxybutyrate) homopolymer (C) to the poly(3-hydroxyalkanoate)-based copolymer (A) is from 0.05 to 0.4.

2. The thermoplastic resin composition according to claim 1, wherein the poly(3-hydroxyalkanoate)-based copolymer (A) has a weight average molecular weight of from 100,000 to 1,000,000.

3. The thermoplastic resin composition according to claim 1, wherein the poly(3-hydroxybutyrate) homopolymer (C) has a weight average molecular weight of from 160,000 to 500,000.

4. The thermoplastic resin composition according to claim 1, wherein the poly(3-hydroxyalkanoate)-based copolymer (A) is at least one selected from the group consisting of poly(3-hydroxybutyrate-co-3-hydroxyvalerate), poly(3-hydroxybutyrate-co-3-hydroxyhexanoate), poly(3-hydroxybutyrate-co-3-hydroxyvalerate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

5. The thermoplastic resin composition according to claim 1, wherein the poly(3-hydroxyalkanoate)-based copolymer (A) is poly(3-hydroxybutyrate-co-3-hydroxyhexanoate).

6. The thermoplastic resin composition according to claim 1, comprising from 1 part by weight to 60 parts by weight of the crosslinked resin particles (B) based on 100 parts by weight of a total amount [(A)+(B)+(C)] of the poly(3-hydroxyalkanoate)-based copolymer (A), the crosslinked resin particles (B), and the poly(3-hydroxybutyrate) homopolymer (C).

7. The thermoplastic resin composition according to claim 1, wherein the crosslinked resin particles (B) have a volume average particle diameter of from 0.1 μm to 10.00 μm.

8. The thermoplastic resin composition according to claim 1, wherein the crosslinked resin particles (B) are crosslinked using a peroxide.

9. The thermoplastic resin composition according to claim 8, wherein the crosslinked resin particles (B) are crosslinked in the presence of the peroxide and a polyfunctional compound.

10. The thermoplastic resin composition according to claim 1, wherein a proportion of the polyhydroxyalkanoate-based resin in 100% by weight of the crosslinked resin particles (B) is at least 80% by weight.

11. A molded article comprising the thermoplastic resin composition according to claim 1.

12. The molded article according to claim 11, which is a sheet molded product, a film molded product, a blow molded product, an extrusion molded product, a vacuum molded product, or an injection molded product.

13. The molded article according to claim 11, which is a resin tube.
